(19) United States
(12) Patent Application Publication
(10) Pub. No.: US 2017/0255664 A1
(43) Pub. Date: Sep. 7, 2017

(54) Data Interchange De-duplication Vault (D.I.D.V.)

(71) Applicants: Nikhir Kumar, Reston, VA (US); Jeffrey John Denecke, SR., Jericho, NY (US)

(72) Inventors: Nikhir Kumar, Reston, VA (US); Jeffrey John Denecke, SR., Jericho, NY (US)

(21) Appl. No.: 14/515,893

(22) Filed: Oct. 16, 2014

Related U.S. Application Data
(60) Provisional application No. 62/022,967, filed on Jul. 10, 2014.

(51) Int. Cl. G06F 17/30; G06Q 10/10

(52) U.S. Cl. CPC G06F 17/30371; G06F 17/30569; G06Q 10/10

(57) ABSTRACT

The Data Interface De-duplication Vault is a distributed software system to provide control to an organization over their data. The software can be housed on the premises of an organization or in the cloud.
The system will provide three fundamental capabilities:
1. Catalog and consolidate data elements from multiple sources, (on premise or cloud), into a persistent single system of record and be able to export this system of record to another single repository.
2. De-duplicate and transform elements with the same value and type from multiple sources into a single business value with associated modifiers that will describe the source and associated relationships and activities.
3. Propagate values received from one source to all other registered systems able to take input and configured to receive the changes.

### RELATED APPLICATION

This application claims the priority benefit of U.S. Provisional Application No. 62/022,967, filed on Jul. 10, 2014, pending entitled “Data Interchange De-duplication Vault (D.I.D.V)”, the entire disclosure of which is incorporated by reference in its entirety herein.

### FIELD OF THE INVENTION

Information Technology—Cloud Software and Data Storage Systems.

### CITATIONS

### US Patent Documents

| | | |
|---|---|---|
| 6,424,358 | July 2002 | DiDomizio, et al |
| 7,246,128 | July 2007 | Jordahl, et al |
| 6,704,747 | March 2004 | Fong |

### OTHER REFERENCES

1. Database: http://en.wikipedia.org/wiki/Database
2. Cloud Computing:
   a. http://csrc.nist.gov/publications/nistpubs/800-145/SP800-145.pdf
   b. http://en.wikipedia.org/wiki/Cloud computing
3. Software as a Service (SaaS):
   a. http://en.wikipedia.org/wiki/Software as a service
   b. http://csrc.nist.gov/publications/nistpubs/800-145/SP800-145.pdf
4. Platform as a service (PaaS)
   a. http://csrc.nist.gov/publications/nistpubs/800-145/SP800-145.pdf
   b. http://en.wikipedia.org/wiki/Platform as a service
5. Infrastructure as a Service (IaaS):
   a. http://csrc.nist.gov/publications/nistpubs/800-145/SP800-145.pdf
   b. http://searchcloudcomputing.techtarget.com/definition/Infrastructure-as-a-Service-IaaS
6. Linked list:
   a. http://en.wikipedia.org/wiki/Linked list
7. Data dictionary:
   a. http://en.wikipedia.org/wiki/Data dictionary
8. Thomas R Gruber; A translation approach to portable ontology specifications;
   Knowledge Systems Laboratory, Technical Report KSL 92-71; April 1993

### BACKGROUND

With the explosion of cloud computing, organizations face these very real threats:
Loss of the ‘control of their data’
No single ‘system of record’
Egregious lock-in to a specific vendor for software and processing

While previous inventions and innovations have addressed aspects of the problems such as Data Loss Protection by addressing security of storage in the cloud, or security during transactional sessions, these measures still do not address the greater problem of giving transparent data definitions with custodial copies of the data to the client organization.

Most organizations today do not have a single system of record because most organizations rely upon more than one software system to support their intrinsic functions. However, organizations can make physical back-ups today that are both in their custody and in their control for the purposes of restoration of data or selection of a subset. The movement to the cloud for infrastructure, software, transactional processing and data, disintermediates these custodial and physical boundaries. While the use of multiple failover mechanisms for these services seems to provide a cursory safeguard, in truth these still do not ensure physical custody or access, nor does it preclude withholding of assets and resources during a contract dispute or loss of assets and resources at liquidation of a service vendor.

Egregious lock-in is further enabled by this loss of physical custody of data, systems and transactions because the recourse to rapid fee hiking or institution of ancillary charges by a

Cloud service provider is to switch to another competing provider, but how is this done effectively when the true set of data required to operate the business is not readily or physically accessible for ingestion or use by the competing vendor.

This underlying risk in moving critical systems to the cloud without appropriate safeguards other than contractual terms is not readily recognized or well understood by many organizational owners and leaders. The damage to brand, extraordinary recovery costs and loss of recoverability cannot be understated.

The invention detailed within this patent application addresses the foundational issues of data custody and control, data as a physical record and delivery of any or all data collected in any format to any software system.

Description of the Invention

### DESCRIPTION OF THE DRAWINGS

FIG. 1: Current State Problem—data fragmentation viewpoint

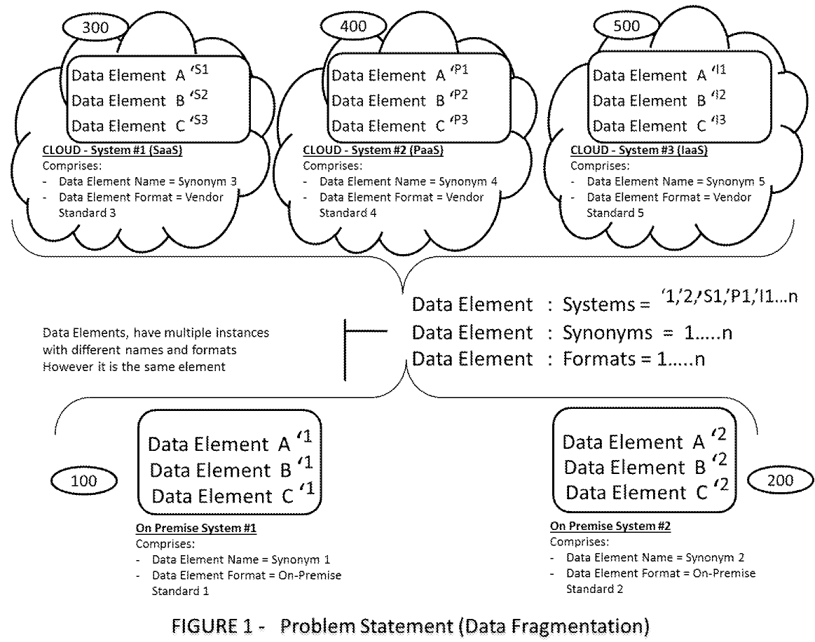

Current State problem depiction, where an organization has multiple disparate sources and operational stores of data, with duplicate data elements.

FIG. 2: Current State Problem—user viewpoint

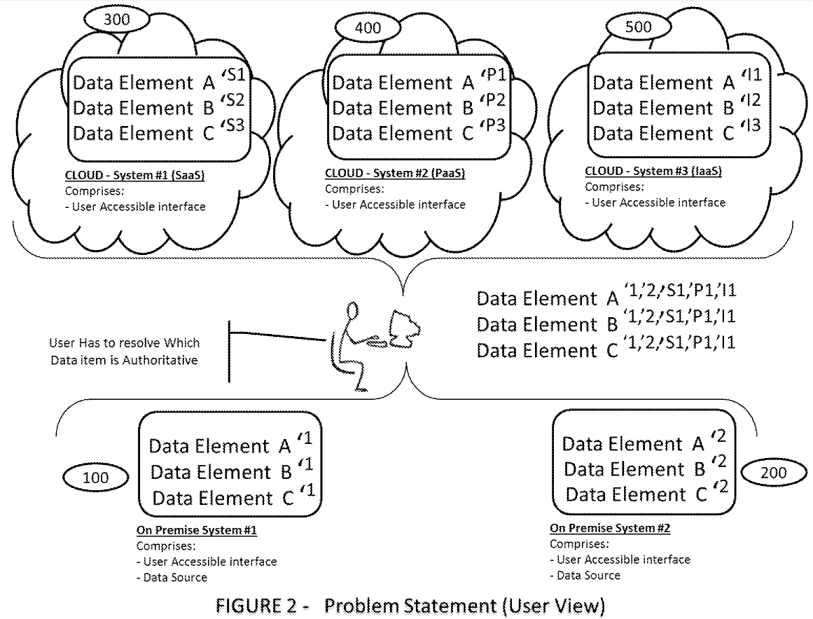

Current State problem depiction, where users have multiple disparate sources and operational stores of data and have to deal with non-authoritative data and resolution.

FIG. 3: Current State Problem—organizational viewpoint

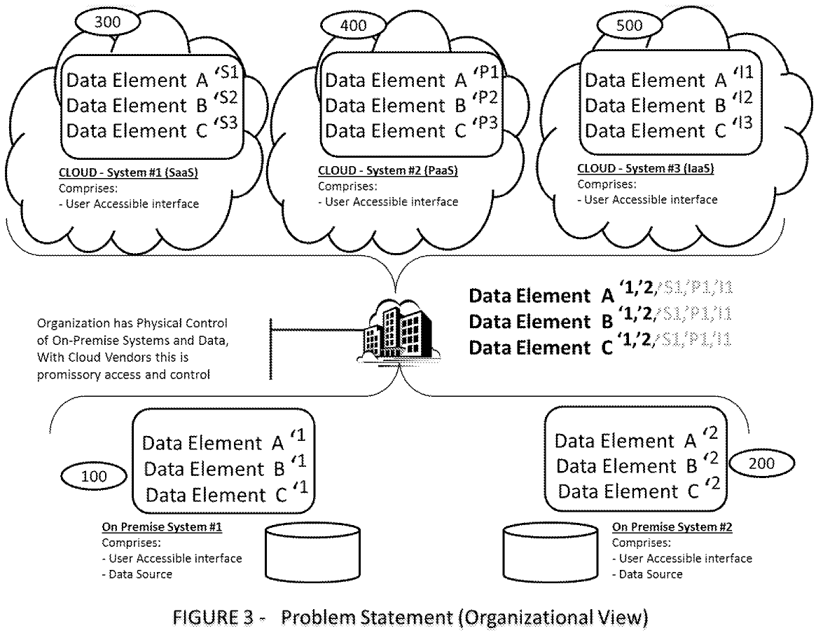

Current State problem depiction, where an organization has multiple cloud based sources and operational stores of data. Should the cloud provider be physically disabled or shutdown, client organizations will face the risk of loss of data leading to loss of operational viability and becoming defunct.

FIG. 4: Data Interchange De-Duplication Vault (D.I.D.V.)

The proposed invention, a distributed software system that can capture data while it is in motion across processing interfaces, de-duplicate, store and distribute to multiple target systems and repositories.

FIG. 5: D.I.D.V. Solution—Solution view

The proposed invention and the basic interactions with other systems.

FIG. 6: D.I.D.V. Solution—Solution view (Data View)

The proposed invention and its capabilities in identifying duplicate data elements by creating a synonym list from each attached ingestion system interaction. The figure illustrates an example of the data from all the systems.

FIG. 7: D.I.D.V. Solution—Solution view propagation (End user view)

The figure illustrates how a user action to update data elements in one system is propagated seamlessly across all other registered systems. When the user access the same data element in a different system the updated value is returned seamlessly.

FIG. 8: D.I.D.V. Solution—Solution view single system of record

The figure illustrates the use of D.I.D.V. as a single system of record across all cloud and on premise systems, with the ability to support the production of organizational data in reports, data cubes or relational databases.

FIG. 9: D.I.D.V. Solution—Solution view (Replace cloud vendor)

Illustrates how a current cloud systems provider can be replaced by a new provider with no disruptions, maintaining the integrity of the corporate data in propagation to the new provider.

### DETAILED DESCRIPTION

The proposed invention (D.I.D.V.) is a distributed software system that can capture data while it is in motion across processing interfaces, de-duplicate, store and distribute to multiple target systems and repositories.

The D.I.D.V. will serve as the single authoritative system of record; allowing data to be physically possessed and under the control of the owning organization, enabling propagation of core data to multiple target systems or cloud services. D.I.D.V. will encompass interfaces that work for both on premise and cloud systems and have mechanisms to capture, ingest, de-duplicate, store, propagate and render an organization's data, regardless of cloud or technology supply chain. It will also have a human user interface to enable configuration and controls for management, security, location and delivery.

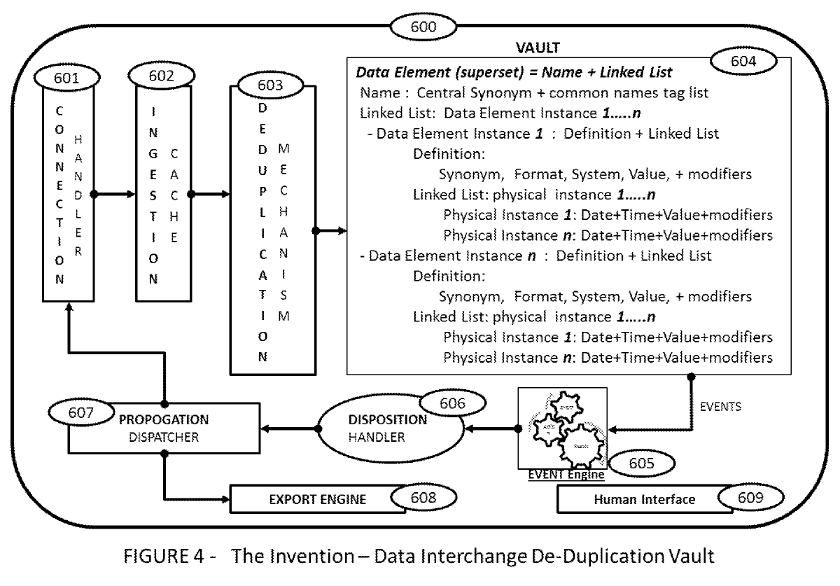

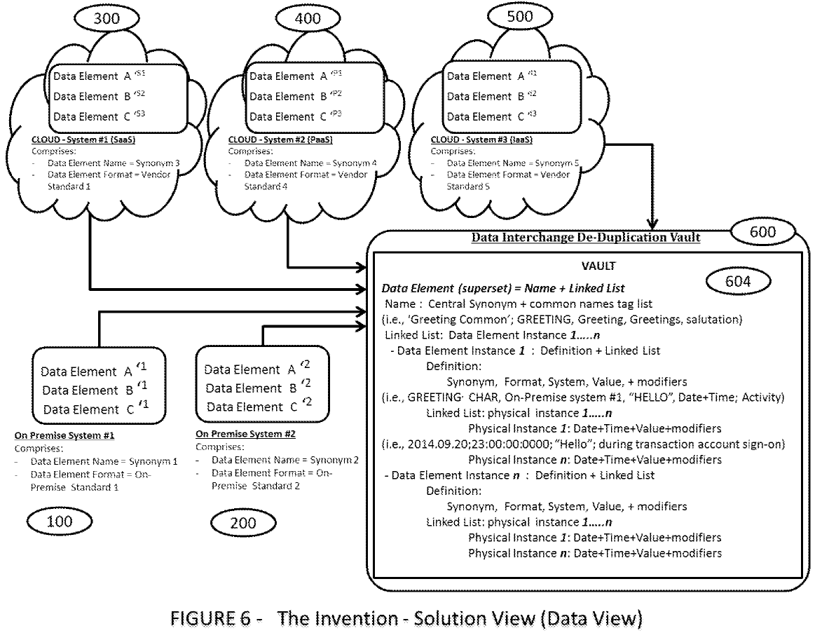

This new distributed software system will comprise major software components as depicted in FIG. 4. 600:
1. Connection Handler (FIG. 4. 601):
   Connection handler will embody a software adaptor that can be inserted at either the point of origin or point of termination or in the network as a proxy across an inter-process connection. This adaptor will act as a pass-through to or from the original recipient be it vendor, product or standards specific. On inbound connections it will implement a store and forward mechanism to pass this inter-process session to the ingestion cache (FIG. 4. 602). On outbound connections it will provide the session connections for the
   propagation dispatcher (FIG. 4. 607). This connection mechanism will implement a software adaptor comprised of a network protocol/session handler and one or more software interfaces that enable the interchange semantics applicable to each source or target system/service. Connection handler will include connection interfaces for both cloud based and on premise systems.
2. Ingestion Cache (FIG. 4. 602):
   Ingestion cache is a transitory store for the persisting the data that is being received from various connections that are part of the connection handler. The data will be uniquely identified by the connection system and the date and time stamp. The cache will encompass the translation engine for manipulating in-bound content and values.
3. De-Duplication Mechanism (FIG. 4. 603):
   A de-duplication engine for normalization of multiple equivalent values into a single normalized business value with associated contextual modifiers. The de-duplication engine will read values of the same kind and de-duplicate them to a single physical value. It will also create the synonym directory to parse the data elements into a single unique data element type, format and name.
4. Vault (FIG. 4. 604):
   The “vault”, houses the de-duplicated values as the “system of record”. The data vault implements a storage mechanism, which orders and attaches data being stored, as linked lists belonging to a prime superset record.
   Each superset record is comprised of a central data synonym and all common tag names for each possible alternate synonym and a reference pointer to the list of linked tag names being captured(Linked-list #1). This linked list of synonym records occurs by {name; format; system; value; modifiers, Linked-list reference}.
   The example depicted in FIG. 6 shows how a superset record for data name “Greeting Common” also references common tags: {GREETING, Greeting, Greetings, salutation} and Link-list reference #1.
   The linked-list reference #1 in turn points to individual records for each common tag. So as seen in FIG. 6, the first data element instance within the linked list for the common tag called “GREETING” would depict {Synonym, Format, System, Value, +modifiers, Linked-list reference #2} as follows: {GREETING, CHAR, On-Premise system #1, “HELLO”, Date+Time; Activity, +Linked-list reference #2}.
   This entry from linked list #1 will in turn contain a reference to the second linked-list of records pointing to each physical interaction for this unique name and system combination containing {Date+Time+Value+modifiers}. This is depicted by the example in FIG. 6. 604: {2014.09.20;23:00:00:0000; “Hello”; during transaction account sign-on}.
5. Event Engine (FIG. 4. 605):
   A data profile and rules engine that supports actions upon an event trigger for the purposes of propagation or delivery of values to outbound targets.
6. Disposition Handler (FIG. 4. 06):
   A high performance access and storage algorithm with create, read, update, delete, archive and export methods. This will include the ability to queue deliveries and/or raise alerts.
7. Propagation Dispatcher (FIG. 4. 607)
   The propagation dispatcher will be the controlling mechanism to initiate outbound data updates to various participating systems. The propagation mechanism will be triggered by the disposition handler (FIG. 4. 606) and will initiate an outbound connector through the connection handler (FIG. 4. 601). Should the propagation semantics fail the data stream will be queued back to the propagation dispatcher for re-transmission or remediation.
8. Export Engine (FIG. 4. 608)
   A vault replicator that enables a physical copy of the data to be exported to an externally consumable format such as a relational data model. The rendering from the export engine will enable organizations to create one or more physical copies of their system of record data in multiple formats, i.e., relational, columnar, indexed, flat file, paper etc.
9. The Visualization and Management Interface (FIG. 4.609):
   The D.I.D.V. is human accessible via a graphical user interface or an internet browser. This component will enable the data contained in the vault to be visualized, reported upon or managed. It will also enable the management and support of the system and its various configuration parameters. It will provide functional interfaces for the administration of data profiles, rule sets and event triggers.
   The user interface will enable role based access to configuration parameters, profiles, rules and rendering methods for data contained in the vault.
   Various interface'screens will enable the management and support of the system and its various configuration parameters. It will also provide functional interfaces for the administration of data profiles, rule sets and event triggers.

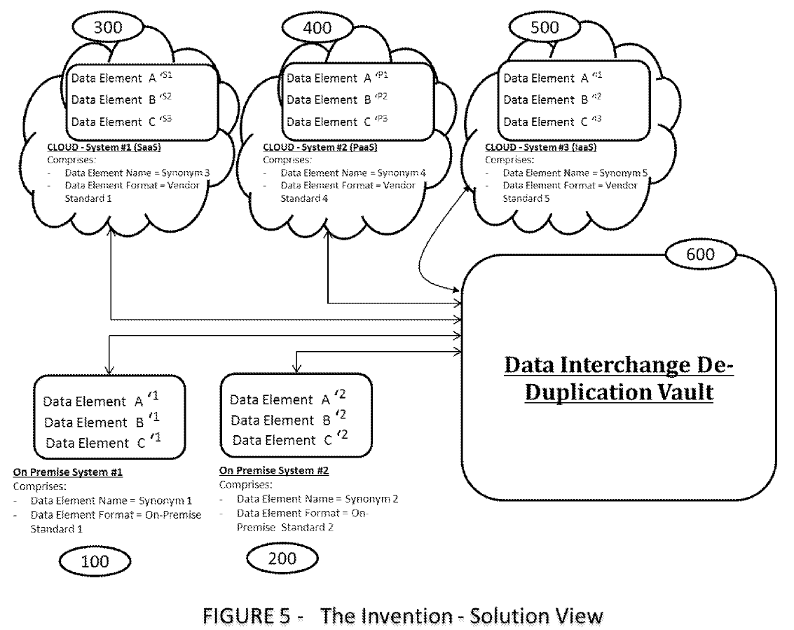

The interactions of D.I.D.V. with other organizational systems are depicted in FIG. 5. The system is able to read and write from/to on premise and cloud based systems, which hold an organizations data, via the custom connection handler (FIG. 4. 601).

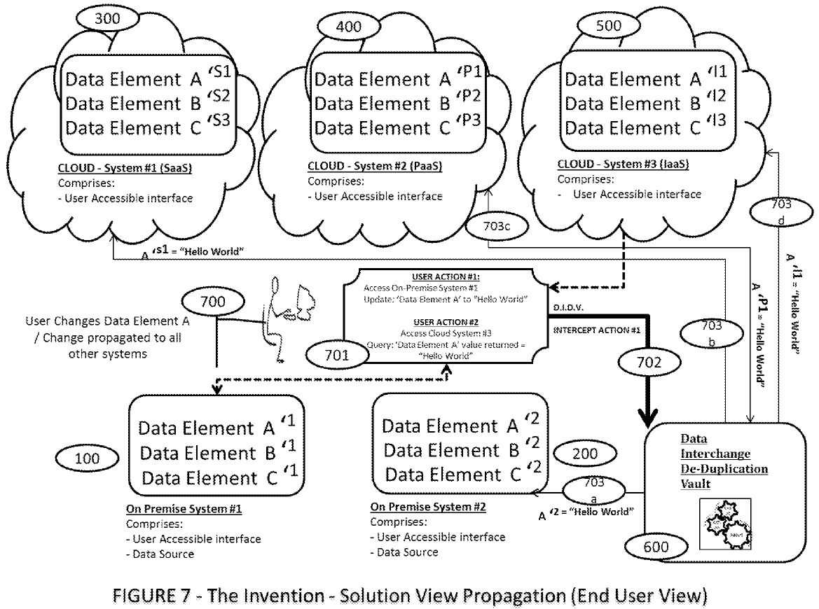

D.I.D.V. enables the smart management of data synchronization for all cloud based systems and in house apps related to an organization. FIG. 7 illustrates how the D.I.D.V. keeps the organizational data synchronized across all on premise and cloud based systems. In FIG. 7 the interactions of user (FIG. 7. 700) with corporate systems are illustrated. The user reviews work on the system #1 (FIG. 7. 100), which is on premise and executes the user action #1 (FIG. 7. 701). This action is to update the value of the data element 100. Data Element A⁺¹ to “Hello World”.

As soon as the user saves this value the connection handler of the D.I.D.V. detects an updated value of the data element and initiates the D.I.D.V. Intercept Action #1 (FIG. 7. 702). This will update the D.I.D.V. vault (FIG. 4. 604). Once the value is updated an action is forwarded to the event engine to (FIG. 4. 605). The update will include the data element information and the changed value. The event engine then determines the target systems that should be updated. It then passes all the information to the Disposition Handler (FIG. 4. 606) which will format the updates in the individual system formats, based on the systems to be updated. In turn the disposition handler will pass on the information to the propagation dispatcher (FIG. 4. 607) and to the connection handler (FIG. 4.601) which will write to the target systems (FIG. 7. 703a, b,c,d)

As shown in FIG. 7 all the systems (FIG. 7. 200, 300, 400, 500) will then have the updated value for the same data element. This keeps the data consistent across all systems. Subsequently the user (FIG. 7. 700) initiates user action #2 (FIG. 7. 701) which reads the data element A from Cloud System #3. The value displayed to the user is the updated value—“Hello World”.

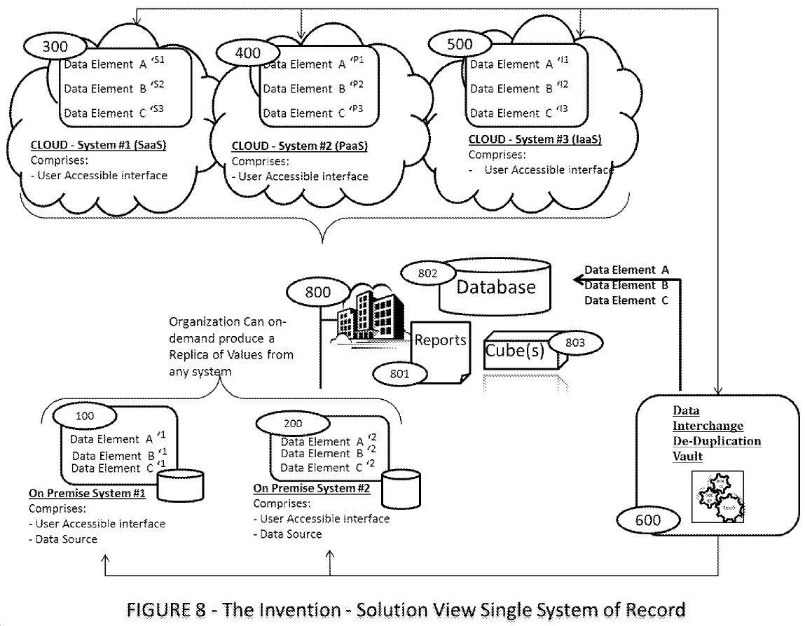

D.I.D.V. frees organizations from lock-in to a particular service provider because “They have our data, hostage” scenarios. It enables a “fail-safe” for all corporations by guaranteeing enterprise data at rest is 100% available to synchronize down to whatever recovery systems, repositories as required and ensures real ownership and control for any organization and their data. As illustrated in FIG. 8 the D.I.D.V. is able to write out all the data elements to the organization (FIG. 8. 800), on demand. All of organization's data is available on-demand to be exported into various formats, be it relational database (FIG. 8. 802), cubes (FIG. 8. 803) or used to be reported on by creating reports (FIG. 8. 801).

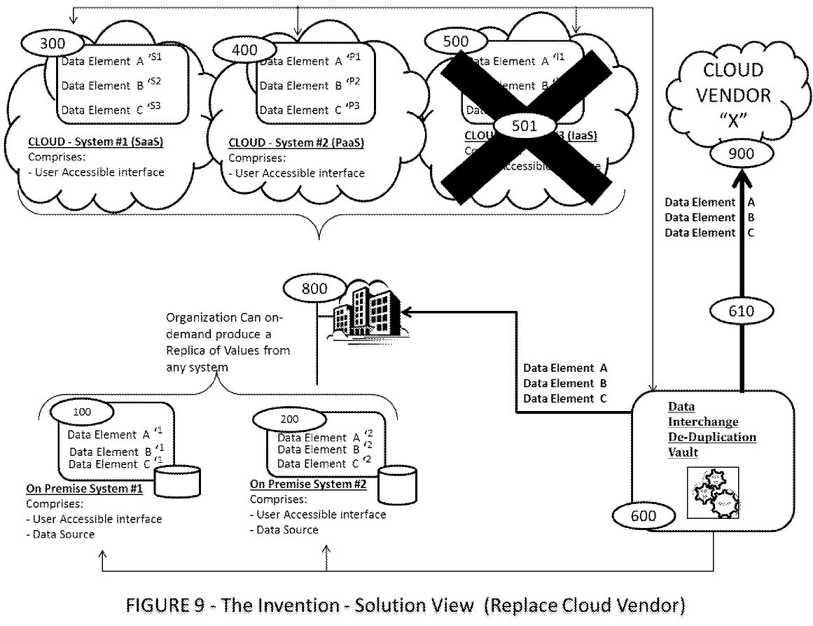

FIG. 9 illustrates the scenario where D.I.D.V. can be used to avoid business disruption when any of the cloud based systems may not be available due to a dispute, service disruption, contract negotiations, egregious price hikes etc. In FIG. 9 consider the scenario where Cloud—System #3 (FIG. 9. 500) is unavailable (FIG. 9. 501). The corporation simply uses the D.I.D.V. (which is the system of record—FIG. 9. 600) to export the data in a normalized fashion using the export engine (FIG. 4. 608). This action is denoted by (FIG. 4. 610). This export can then be directed to a new cloud vendor system (FIG. 9. 900), allowing the corporation to continue its business function with minimal to no disruptions.

### ADVANTAGEOUS EFFECTS OF THE INVENTION

The D.I.D.V. is more than just another software system; its embodiment provides a missing safeguard for an organization migrating data and processes into cloud based systems and infrastructure. It supports organizational independence from suppliers including the D.I.D.V. itself, while also ensuring control of critical core data and rules for sustaining organizational operations:
1. Organizations can for the first time automatically create a single system of record with accessible copies in multiple database and file formats.
2. It enables data integration across distributed systems that can quickly locate, reformat, rename and populate data from one system or service to another without the need for programmer customization.
3. Remove dependencies on cloud services providers and free organizations from lock-ins, by enabling fast provisioning of data onto any service/software/data provider
4. Enable mass conversions based upon input format desriptors that encompass any database, file, programming language or messaging standard.
5. Enable the smart management of data synchronization for all cloud and in house applications related to an organization.
6. Enable a “fail-safe” for all corporations by guaranteeing enterprise data at rest is 100% available to synch down to whatever recovery systems, repositories as required.
7. Ensure real ownership and control for an organization over their data.

What is claimed:

1. The D.I.D.V. uniquely combines: connectors for cloud and on-premise enterprise systems/applications; de-duplication of interchangeable data elements; data aggregation;
propagation of aggregated data to target systems to maintain enterprise data uniformity, quality, integrity in real time; giving enterprises/organizations control of data preventing cloud vendor lock-in and creating a system of record, by providing exportation and search.

2. The method of claim 1, wherein including connectors to cloud based or on-premise data systems.

3. The method of claim 1, wherein including a cache for the ingested data for transformation of data.

4. The method of claim 1, wherein including a de-duplication method for all interchangeable or redundant enterprise data elements from individual systems.

5. The method of claim 1, wherein including a data aggregation mechanism for all data elements identified for capture.

6. The method of claim 1, wherein including a propagation mechanism to the target systems.

7. The method of claim 4, utilize commercially available de-duplication software to create a synonym library.

8. The method of claims 2 & 6, utilize commercially available Internet based connectors.

9. The method of 1, wherein including utilization of commercially available search mechanisms.

10. The method of 3, wherein including the utilization of commercially available cache mechanisms.
